(19) United States
(12) Patent Application Publication
(10) Pub. No.: US 2003/0106185 A1
(43) Pub. Date: Jun. 12, 2003

(54) Fitment mountable to panel

(76) Inventor: James L. Worrell, DeKalb, IL (US)

Correspondence Address: Wood, Phillips, Katz, Clark & Mortimer, Citicorp Center, Suite 3800, 500 West Madison Street, Chicago, IL, 60661-2511, US

(21) Appl. No.: 10/020,775

(22) Filed: Dec. 12, 2001

(51) Int. Cl. E05B 1/00; B62B 1/00

(52) U.S. Cl. 16/444

(57) ABSTRACT

A fitment mountable to a panel, via two projecting studs, comprises a block and a key. The block has a recess receiving the heads of the studs and a slot communicating with the recess. The recess and the slot permit the shanks of the studs but not the heads of the studs to pass through the slot and the fitment to be moved in a direction along the slot. A closed end of the slot engages the shank of one stud so as to prevent the fitment from being moved in a given direction, beyond a terminal position. The key is adapted to be removably pressed into an aperture in the block, across an exposed portion of the shank of one such stud, so as to lock the fitment approximately in the terminal position. Two such fitments are combined with an elongate handle having two ends, each end being fastened to one such fitment, via a concealed fastener.

### TECHNICAL FIELD OF THE INVENTION

This invention pertains generally to a fitment mountable to a panel via a stud projecting from the panel. The invention is intended to be particularly useful for a handle-mounting fitment mountable to a door panel of an appliance, such as an oven or a refrigerator.

### BACKGROUND OF THE INVENTION

According to a prior design, each end of an elongate handle is mounted to a a door panel of an appliance, such as an oven or a refrigerator, over a fitment coacting with a stud projecting from the panel. The stud has a shank and a head, which is spaced from the panel by an exposed portion of the shank. The fitment at each end of the handle has a block having an elongate recess, which is adapted to receive the head of the stud and to permit the block to be then moved in a direction along the recess. Moreover, the block has an elongate slot, which extends along and communicates with the recess and which is adapted, when the head of the stud is received by the recess, to permit the exposed portion of the shank of the stud but not the head of the stud to pass through the slot.

According to the prior design noted above, at each end of the handle, a threaded fastener is threaded through an aperture opening at an outer face of said end of the handle, into the door panel, so as to fasten the handle to the door panel. The threaded fastener does not pass through the block of the fitment. The fitments resist forces imparted by a user and tending to pull the handle from the door panel. Moreover, at each end of the handle, a small plug is inserted into the aperture opening at the outer face, so as to conceal the threaded fastener. It is necessary to provide for the handle to retain each plug in the aperture receiving said plug with sufficient force to avoid a choking hazard for a child encountering the handle.

### SUMMARY OF THE INVENTION

This invention provides an improved fitment, which is mountable to a panel, via a stud projecting from the panel, having a shank, and having a head, which head is spaced from the panel by an exposed portion of the shank. The improved fitment comprises a block, as described below, and a key, as described below. In contemplated embodiments, the improved fitment can be removably mounted to the panel without a threaded fastener or a small plug, as described above.

The block has an elongate recess, which is adapted to receive the head of the stud, and an elongate slot, which extends along and communicates with the recess. The slot, which has a closed end and an opposite end, is adapted, when the head of the stud is received by the recess, to permit the exposed portion of the shank of the stud but not the head of the stud to pass through the slot. The recess and the slot are adapted to permit the block to be then moved in a direction along the recess and along the slot so as to cause the closed end to approach the shank of the stud. The closed end of the slot is adapted to engage the shank of the stud so as to prevent the block from being moved in a given direction, beyond a terminal position relative to the stud.

The key is adapted to be removably inserted into an aperture in the block, between the stud and the opposite end of the slot, so as to lock the fitment approximately in the terminal position. Preferably, the key is adapted to be removably pressed into the aperture in the block, across the stud, between the head of the stud and the panel.

This invention further provides a combination comprising a fitment, as described above, and a handle fastened to the fitment. The handle has an aperture providing access to the head of the key. Preferably, in such a combination, the key has a shank, which shank is adapted to be removably pressed into the aperture in the block, and the key has a head, which head is adapted to be removably pressed into the aperture in the handle. In a preferred embodiment of this invention, the fitment is one of two similar fitments combined with an elongate handle, which is fastened to each fitment at a given end of the handle.

### BRIEF DESCRIPTION OF THE DRAWINGS

FIG. 1 is a fragmentary, perspective, exploded view of an oven having a door, to which an elongate handle is mountable via two fitments embodying this invention.

FIG. 2, on a larger scale compared to FIG. 1, is a simplified, plan view showing successive movements as the handle is being mounted to the oven door.

FIGS. 3, 4, and 5, on a larger scale compared to FIG. 2, are fragmentary, exploded views showing successive stages, at one end of the handle, as the handle is being mounted to the oven door via a fitment comprising a block and a key and embodying this invention.

FIG. 5 also shows, fragmentarily, that a tip of a screwdriver is useful to pry the key of the fitment from the block of the fitment.

FIG. 6 is a fragmentary, sectional detail showing such a tip being used to pry the key from the block.

FIG. 7 is a sectional detail, as taken along line 7—7 in FIG. 5, in a direction indicated by arrows.

### DETAILED DESCRIPTION OF THE ILLUSTRATED EMBODIMENT

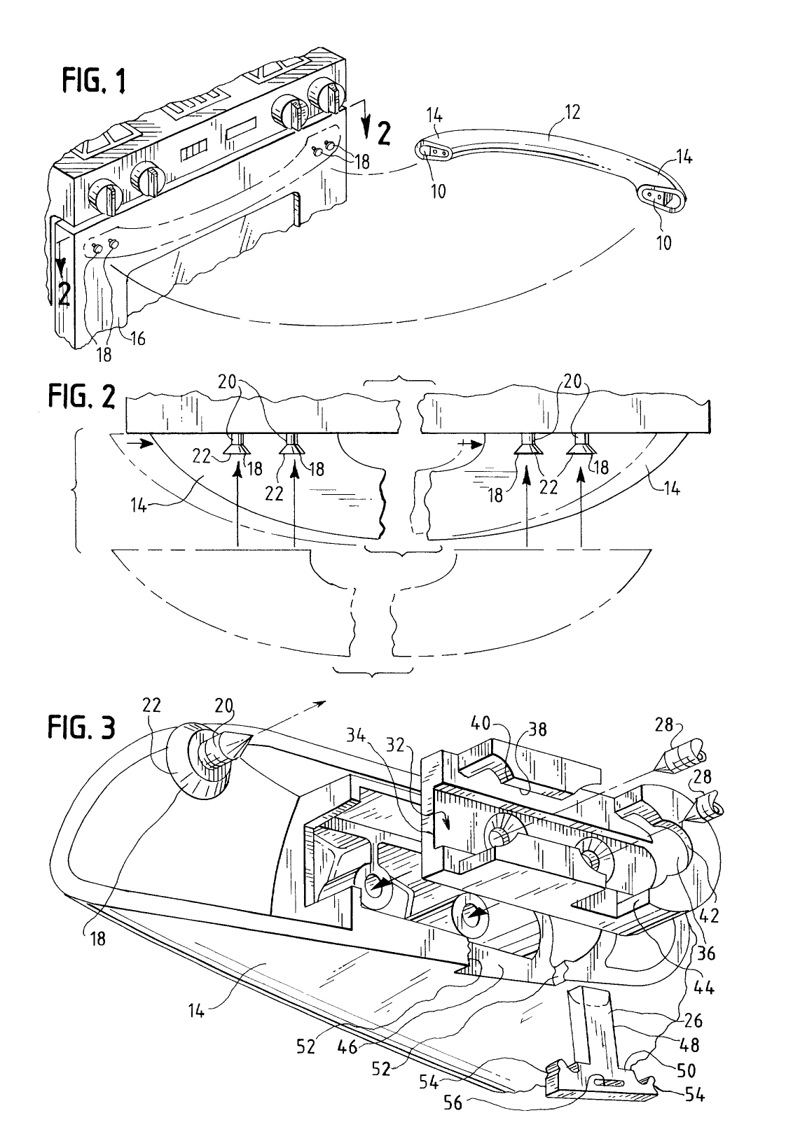

As illustrated in FIG. 1, two similar fitments 10, each embodying this invention, are being used to mount an elongate handle 12 having two similar, opposite ends 14, to a panel 16, via two pairs of similar studs 18, of which one pair is associated with each end 14 of the handle. As illustrated in FIG. 2, each stud 18 has a shank 20, which penetrates the panel 16 and is fastened to the panel 16 in a known manner, and a head 22, which is spaced from the panel 16 by an exposed portion of the shank 20. In the embodiment illustrated in FIG. 1, the panel 16 is on an oven door. The handle 12 is molded from an engineering polymer, such as polybutadiene terephthalate, which is preferred for a handle mounted to an oven door, as illustrated, or polypropylene, which is preferred for a handle mounted to a refrigerator door.

As illustrated in FIGS. 3, 4, and 5, each fitment 10 comprises a block 24 and a key 26. Preferably, the blocks 24 of the fitments 10 are molded from an engineering polymer of a type that conducts heat poorly, such as DELRIN™ acetal, a DuPont polymer, and the keys 26 of the fitments 10 are molded from the engineering polymer that is used to mold the handle 1. The blocks 24 and the handle 12 are colored similarly. As illustrated in FIG. 3, the block 24 of each fitment 10 is fastened to an associated end 14 of the handle 12, via two screws 28, which are concealed when the handle 12 is mounted to the panel 14 and each of which is driven through an associated, countersunk hole 30 in the block 24, into an associated socket 32 in the handle end 14.

As illustrated in FIGS. 3, 4, and 5, the block 24 of each fitment 10 is molded so as to have an elongate recess 32, which has two opposite ends, i.e., an open end 34 and a closed end 36. Moreover, the block 24 of each fitment 10 has an elongate slot 38, which extends along and communicates with the recess 32 and which has two opposite ends, i.e., an open end 40 and a closed end 42. The recess 32 is adapted to receive the heads 22 of the associated studs 18, at the open end 34. The open end 40 of the slot 38 permits the recess 32 to receive the heads 22 of the associated studs 18. The slot 38 is adapted, when the heads 22 of the associated studs 18 are received by the recess 32, to permit the exposed portions of the shanks 20 of the associated studs 18 but not the heads 22 of the associated studs 18 to pass through the slot 38. The recess 32 and the slot 38 are adapted to permit the block 24 to be then moved in a direction along the recess 32 and along the slot 38 so as to cause the closed end 42 of the slot 38 to approach the exposed portion of the shank 20 of whichever of the associated studs 16 is nearer. The closed end 42 of the slot 38 is adapted to engage the exposed portion of the shank 20 of whichever of the associated studs 16 is nearer, between the exposed portion thereof and the open end 40 of the slot 38, so as to prevent the block 24 from being moved in a given direction, beyond a terminal position relative to the associated stud 18.

As illustrated in FIGS. 3, 4, and 5, the block 24 of each fitment 10 is molded so as to have a comparatively narrow aperture 44, which accommodates the key 26 of the same fitment 10. Moreover, the associated end 14 of the handle 12 is molded so as to have a comparatively wider aperture 46, which, when the block 24 is fastened to the same end 14, communicates with the aperture 44 in the block 24. Moreover, the key 26 of each fitment 10 is molded so as to have a comparatively narrower shank 48, which has a hexagonal profile, and so as to have a comparatively wider head 50. The shank 48 of the key 26 is adapted to be removably pressed into the aperture 44 in the block 24, across a nearer stud 18 of the associated studs 18, between the nearer stud 18 and the open end 40 of the slot 38 and between the head 22 of the nearer stud 18 and the panel 16, so as to lock the block 24 approximately in the terminal position. The head 50 of the key 26 is adapted to be removably pressed into the aperture 44 in the handle end 14 when the shank 48 of the key 26 is pressed removably into the aperture 44 in the block 24. The handle end 14 and the key 26 are molded so that formations 52 defined by the aperture 46, at two opposite walls of the aperture 46, and formations 54 defined by the head 50 of the key 24, at two opposite ends of the head 50 of the key 26, enable the head 50 of the key 26 to be snap-fitted into the aperture 46 in the handle end 14. The head 50 of the key 26 has an outer surface that conforms closely in curvature, surface color, and surface finish to adjacent regions of the outer surface of the handle end 14, so that the head 50 of the key 26 is inconspicuous when snap-fitted into the apertures 46 in the handle end 14.

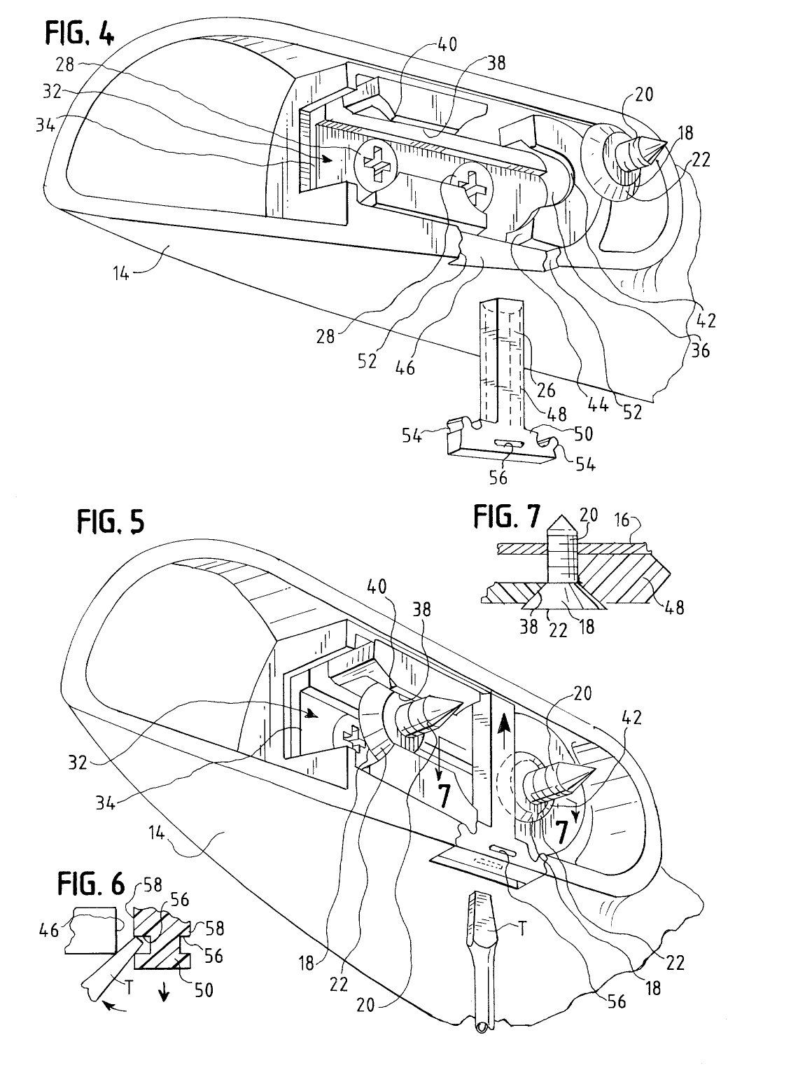

As illustrated in FIGS. 5, 6, and 7, at each end 14 of the handle 12, the head 50 of the key 26 is molded so as to have two slots 56, which open on opposite sides 58 of the head 50 each of which is adapted to receive a tool T, such as a tip of a screwdriver. The tool T can be thus used as a lever, which can bear against an edge of the aperture 46, to pry the key 26 from the block 24 and from the handle end 14 with minimal risk of damage to the key 26 or to the handle end 14, as when repair or replacement of the fitment or the handle 12 is contemplated. So as to minimize possibilities of tampering, it is intended to be somewhat difficult to pry the key 26 therefrom.

Because this invention enables a handle to be readily mounted to a panel, via a stud or studs projecting from the panel, this invention permits the handle of an appliance, such as an oven or a refrigerator, to be shipped separately or to be shipped within a cavity of the appliance, so as to minimize its packaging and shipping volume and consequent packaging and shipping costs, so as to maximize its accessability through doorways, and so as to facilitate interchangeability of its parts with the parts of other appliances.

Although this invention is intended to be particularly useful for a handle-mounting fitment mountable to a door panel of an appliance, such as an oven or a refrigerator, this invention may prove to be similarly useful for a handle-mounting fitment mountable to a door panel of a cabinet, such as a storage or utility cabinet, or for a fitment mountable to a panel of a similar or different type.

1. A fitment mountable to a panel, via a stud projecting from the panel, having a shank, and having a head, which is spaced from the panel by an exposed portion of the shank of the stud, wherein the fitment comprises a block having an elongate recess, which is adapted to receive the head of the stud, wherein the block has an elongate slot, which extends along and communicates with the recess, which has a closed end and an opposite end, and which is adapted, when the head of the stud is received by the recess, to permit the exposed portion of the shank of the stud but not the head of the stud to pass through the slot, wherein the recess and the slot are adapted to permit the block to be then moved in a direction along the recess and along the slot so as to cause the closed end to approach the shank of the stud, wherein the closed end is adapted to engage the exposed portion of the shank of the stud so as to prevent the block from being moved in a given direction, beyond a terminal position relative to the stud, and wherein the fitment further comprises a key, which is adapted to be removably inserted into an aperture in the block, between the stud and the opposite end of the slot, so as to lock the fitment approximately in the terminal position.

2. The fitment of claim 1 wherein the key is adapted to be removably pressed into the aperture in the block, between the stud and the opposite end of the slot.

3. The fitment of claim 1 wherein the key is adapted to be removably inserted into the aperture in the block, across the stud, between the head of the stud and the panel.

4. The fitment of claim 2 wherein the key is adapted to be removably inserted into the aperture in the block, across the stud, between the head of the stud and the panel.

5. A combination comprising the fitment of claim 1, 2, 3, or 4 and further comprising a handle fastened to the fitment, the handle having an aperture providing access to the head of the key.

6. The combination of claim 5 wherein the key has a shank, which is adapted to be removably pressed into the aperture in the block, across the exposed portion of the shank of the stud, and wherein the key has a head, which is adapted to be removably pressed into the aperture in the handle.

7. The combination of claim 6 wherein walls of the aperture in the handle and the head of the key define respective formations enabling the head of the key to be snap-fitted into the aperture in the handle.

8. The combination of claim 5 wherein the fitment is one of two similar fitments and wherein the handle is elongate and is fastened similarly to each fitment at an associated end of the handle.

9. The combination of claim 6 wherein the fitment is one of two similar fitments and wherein the handle is elongate and is fastened similarly to each fitment at an associated end of the handle.

10. The combination of claim 7 wherein the fitment is one of two similar fitments and wherein the handle is elongate and is fastened similarly to each fitment at an associated end of the handle.
